(19) United States
(12) Patent Application Publication
(10) Pub. No.: US 2026/0128608 A1
(43) Pub. Date: May 7, 2026

(54) BATTERY CHARGER

(71) Applicant: MILWAUKEE ELECTRIC TOOL CORPORATION, Brookfield, WI (US)

(72) Inventors: Samuel D. Blake, Pasadena, CA (US); Matthew J. Herro, Pewaukee, WI (US); Daniel J. Mader, Milwaukee, WI (US)

(21) Appl. No.: 19/381,103

(22) Filed: Nov. 6, 2025

Related U.S. Application Data
(60) Provisional application No. 63/716,965, filed on Nov. 6, 2024.

(51) Int. Cl. H02J 7/70; H01R 9/24; H01R 13/52

(52) U.S. Cl. CPC H02J 7/751; H01R 9/2491; H01R 13/5219; H01R 13/5227

(57) ABSTRACT

A battery charger may include a housing assembly. A battery charger may include a battery receptacle coupled to the housing assembly, the battery receptacle including an open end configured to receive a portion of the battery pack and a partially closed end opposite from the open end. A battery charger may include charging electronics positioned within the housing assembly and electrically connected to the battery receptacle. A battery charger may include a conduit positioned within the housing assembly, the conduit including a first end fluidly coupled to the partially closed end of the battery receptacle and a second end fluidly coupled to an outlet of the housing assembly.

### CROSS-REFERENCE TO RELATED APPLICATIONS

This application claims priority to U.S. Provisional Patent Application No. 63/716,965, filed Nov. 6, 2024, the entire content of which is hereby incorporated by reference.

### FIELD

The present disclosure relates to battery chargers and, more particularly, to a water-resistant battery charger.

### BACKGROUND

Liquids, such as water, sea water, etc., or other harmful materials (e.g., salt spray, snow which typically includes minerals, etc.) may enter a battery charger through various entry points including, for example, battery pack receptacles, mechanical latches, mechanical interfaces between portions of a battery charger housing, drain holes in the battery charger housing, etc. If the ingress fluid or material is conductive (e.g., sea water), then when such fluid or material enters the battery charger, a short circuit may occur, for example, between various components of charging electronics within the battery charger.

### SUMMARY

In one independent embodiment, a battery charger configured to charge a battery pack, the battery charger including: a housing assembly; a battery receptacle coupled to the housing assembly, the battery receptacle including an open end configured to receive a portion of the battery pack and a partially closed end opposite from the open end; charging electronics positioned within the housing assembly and electrically connected to the battery receptacle; and a conduit positioned within the housing assembly, the conduit including a first end fluidly coupled to the partially closed end of the battery receptacle and a second end fluidly coupled to an outlet of the housing assembly.

In another independent embodiment, a battery charger configured to charge a battery pack, the battery charger including: a housing assembly; a battery receptacle coupled to the housing assembly, the battery receptacle including an open end configured to receive a portion of the battery pack and a partially closed end opposite from the open end; charging electronics positioned within the housing assembly and electrically connected to the battery receptacle; and a water-tight seal established between a peripheral surface of the battery receptacle and a surface of the housing assembly.

In yet another independent embodiment, a battery charger configured to charge a battery pack, the battery charger including: a housing assembly including an upper housing portion and a lower housing portion; a battery receptacle coupled to the upper housing portion, the battery receptacle including an open end configured to receive a portion of the battery pack and a partially closed end opposite from the open end; charging electronics positioned within the housing assembly beneath the battery receptacle and electrically connected to the battery receptacle; and a conduit positioned within the housing assembly, the conduit including a first end fluidly coupled to the partially closed end of the battery receptacle and a second end fluidly coupled to an outlet of the lower housing portion; wherein the conduit is configured to capture water entering the battery receptacle and direct the water to the outlet.

### BRIEF DESCRIPTION OF THE DRAWINGS

FIG. 1 is a perspective view of a battery charger.

FIG. 2 is a perspective view of a battery pack.

FIG. 3 is a cross-sectional view of the battery charger of FIG. 1, taken along line 3—3 of FIG. 1 and illustrating a battery receptacle of the battery charger.

FIG. 4 is a side view of the battery receptacle of FIG. 3.

FIG. 5 is a top view of the battery receptacle of FIG. 3.

FIG. 6 is a detailed cross-sectional view of the battery charger of FIG. 1, taken along line 6—6 of FIG. 1.

FIG. 7 is a detailed cross-sectional view of the battery charger of FIG. 1, showing detail 7 of FIG. 6.

FIG. 8 is a cross-sectional view of the battery charger of FIG. 1, taken along line 6—6 of FIG. 1 and illustrating a drain conduit of the battery charger according to an embodiment of the present disclosure.

FIG. 9 is a detailed cross-sectional view showing portions of the drain conduit of FIG. 8 coupled to the battery receptacle of FIG. 3.

FIG. 10 is a cross-sectional view of the battery charger of FIG. 1, taken along line 6—6 of FIG. 1 and illustrating a drain conduit of the battery charger according to another embodiment of the present disclosure.

FIG. 11 is a side view of the drain conduit of FIG. 10 coupled to the battery receptacle of FIG. 3.

### DETAILED DESCRIPTION

Before any independent embodiments of the disclosure are explained in detail, it is to be understood that the disclosure is not limited in its application to the details of construction and the arrangement of components set forth in the following description or illustrated in the following drawings. The disclosure is capable of other independent embodiments and of being practiced or of being carried out in various ways.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

Relative terminology, such as, for example, “about”, “approximately”, “substantially”, etc., used in connection with a quantity or condition would be understood by those of ordinary skill to be inclusive of the stated value and has the meaning dictated by the context (for example, the term includes at least the degree of error associated with the measurement of, tolerances (e.g., manufacturing, assembly, use, etc.) associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10% or more) of an indicated value.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

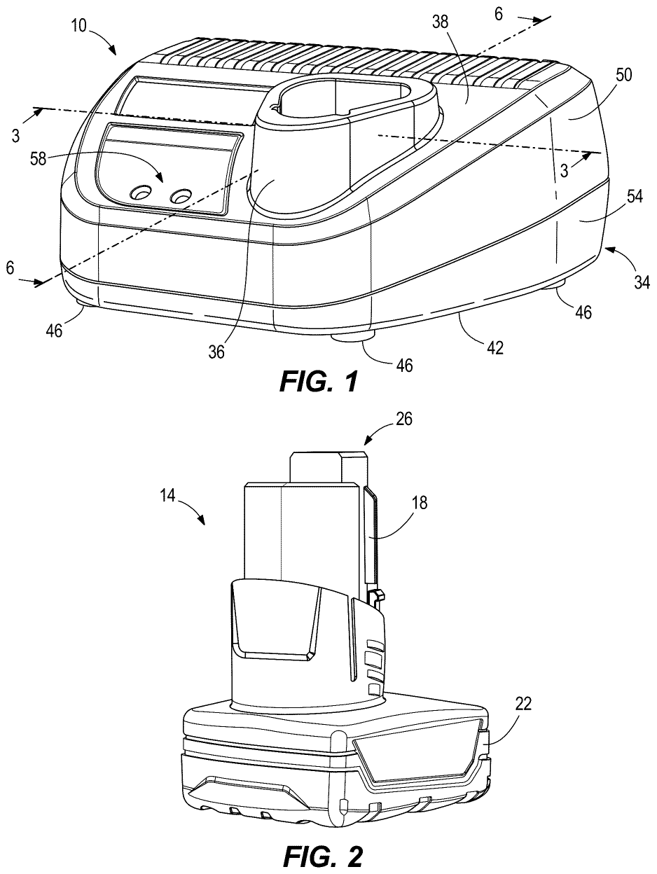

FIG. 1 illustrates a battery charger 10 operable to charge a battery pack, such as the battery pack 14 illustrated in FIG. 2. The battery charger 10 includes one or more features making it water-resistant by preventing ingress of water or by directing water entering the battery charger 10 away from sensitive electronics and back out of the battery pack 14, as will be described herein.

With reference to FIG. 2, the battery pack 14 has a “tower” connection configuration. More specifically, the battery pack 14 includes a “tower” or post 18 which extends from a base 22. The post 18 and the base 22 can each contain battery cells (not shown). The post 18 includes a terminal block 26 which includes a plurality of pack terminals (not shown). The pack terminals are electrically connected to the battery cells. When the battery pack 14 is coupled to a power tool (not shown), the pack terminals make electrical connections with corresponding power tool terminals to electrically connect the battery pack 14 to the power tool. Likewise, when the battery pack 14 is coupled to the battery charger 10, the pack terminals make electrical connections with corresponding charger terminals 30 (FIG. 5) to electrically connect the battery pack 14 to the battery charger 10. The battery pack 14 can have a nominal voltage of, e.g., about 12 volts (V).

Referring again to FIG. 1, the battery charger 10 includes a housing assembly 34 and a battery receptacle 36. The housing assembly 34 includes a top wall 38 and a bottom wall 42. The battery receptacle 36 is coupled to and supported by the top wall 38. The bottom wall 42 supports the battery charger 10 atop a worksurface (not shown), such as a ground or floor surface, or a bench or table top. The bottom wall 42 can include or attach to a plurality of feet 46 which contact the worksurface and elevate the bottom wall 42 above the worksurface. In the illustrated embodiment, the housing assembly 34 includes an upper housing portion 50 defining the top wall 38, and a lower housing portion 54 defining the bottom wall 42. The battery charger 10 further includes an indicator panel 58, including one or more LEDs, displays, or other indicators, which indicates, e.g., a charging status, an overheat status, a fault status, etc.

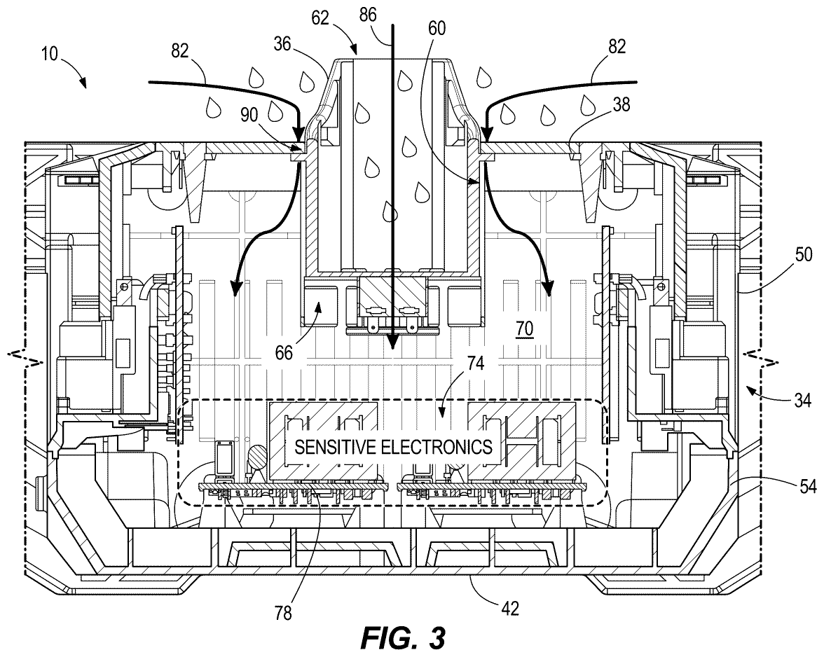

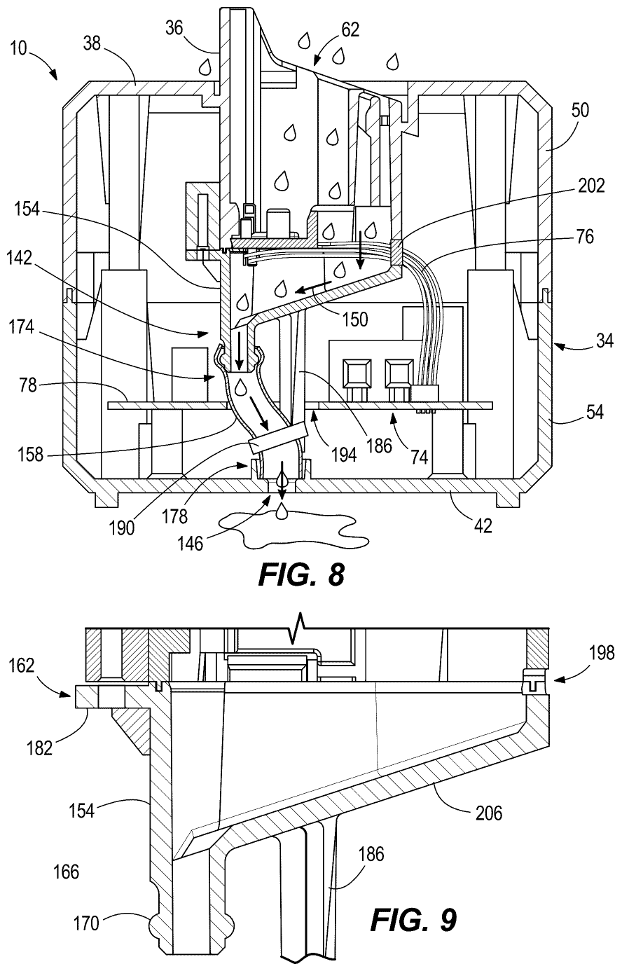

With reference to FIG. 3, the battery receptacle 36 resides within a top wall aperture 60 defined by the top wall 38. The battery receptacle 36 includes an open end 62 and a partially closed end 66 located opposite from the open end 62. The open end 62 selectively and removably receives the post 18 of the battery pack 14. The charger terminals 30 are supported at the partially closed end 66 of the battery receptacle 36. The housing assembly 34 partially encloses an internal space 70 therewithin. The partially closed end 66 protrudes at least partially into the internal space 70. The battery charger 10 further includes charging electronics 74 which are housed within the housing assembly 34 and positioned in the internal space 70. The charging electronics 74 are electrically connected to the charger terminals 30 (FIG. 5), for example, via wires 76 (FIG. 8). When the post 18 is received in the open end 62, the pack terminals make electrical connections with the charger terminals 30 (FIG. 5), and thereby become electrically connected with the charging electronics 74.

The charging electronics 74 are capable of connecting to an external power supply (e.g., via a power cord; not shown) or to an internal power supply (e.g., an onboard battery module within the housing assembly 34; not shown). The charging electronics 74 are operable to output a charging current to the battery pack 14 when the battery pack 14 is connected to the battery receptacle 36. The charging electronics 74 include, among other things, a printed circuit board assembly 78. The printed circuit board assembly 78 can include, e.g., a transformer and other circuitry to rectify and condition AC power received (e.g., via an AC wall outlet) and to provide DC power to the charger terminals 30 and other components of the battery charger 10.

With continued reference to FIG. 3, the charging electronics 74 are positioned below the battery receptacle 36. Stated differently, the charging electronics 74 are positioned beneath the battery receptacle 36. FIG. 3 further illustrates two locations or ingress passageways 82, 86 for ingress of water into the internal space 70 of the housing assembly 34. A first location, or first ingress passageway 82 is an interface 90 between the battery receptacle 36 and the top wall 38. A second location, or second ingress passageway 86 is through the partially closed end 66. Water entering the internal space 70 via one or both of the ingress passageways 82, 86 can potentially encounter the charging electronics 74. Exposing the charging electronics 74 to water can cause problems or failures, or otherwise render the charging electronics 74 inoperable.

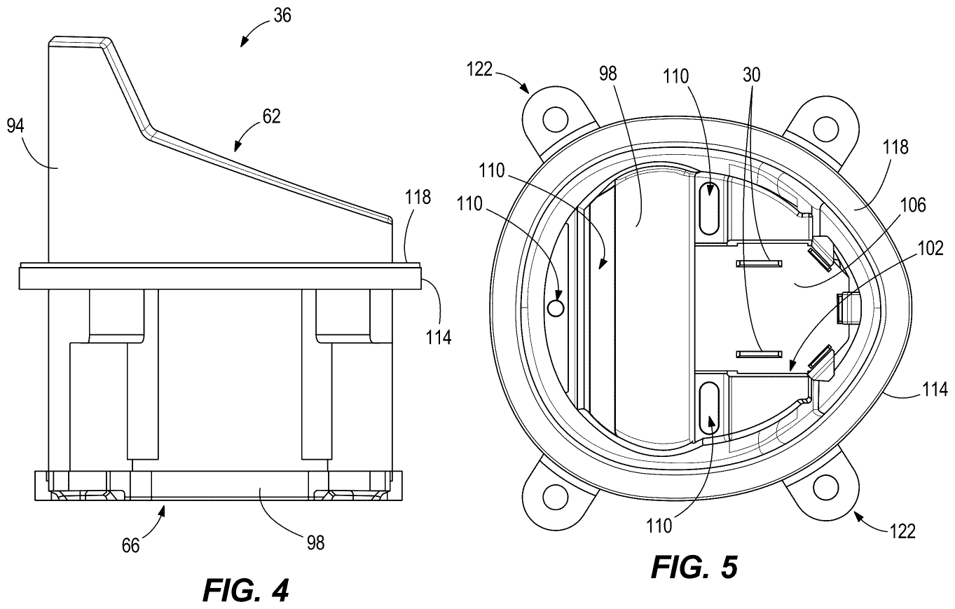

FIGS. 4 and 5 illustrate the battery receptacle 36 in greater detail. The battery receptacle 36 includes an annular sidewall 94 and a base wall 98. The annular sidewall 94 defines the open end 62 and the base wall 98 defines the partially closed end 66. Portions of the annular sidewall 94 and the base wall 98 define a first aperture 102 which receives a terminal block 106 of the battery charger 10. The terminal block 106 supports the charger terminals 30. The base wall 98 also defines a plurality of second apertures 110 or drain apertures. Water entering the battery receptacle 36 via the open end 62 can exit the battery receptacle 36 through the partially closed end 66 via the plurality of second apertures 110. The battery receptacle 36 also includes a transverse rib or a flange 114 protruding outward transversely from and circumscribing the annular sidewall 94. The flange 114 is positioned between the open end 62 and the partially closed end 66. A seal member, or a gasket 118 is disposed on the flange 114 and also surrounds or circumscribes the annular sidewall 94. The battery receptacle 36 further includes a plurality of screw bosses 122 for attaching components to the battery receptacle 36 as will be described herein.

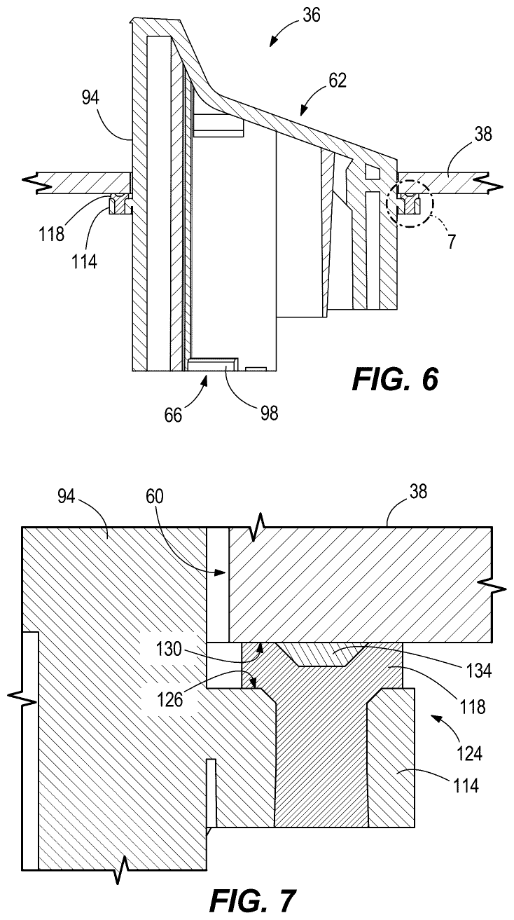

With reference to FIGS. 6 and 7, to prevent ingress of water through the first ingress passageway 82 defined at the interface 90, a water-tight seal 124 is established between a peripheral surface 126 of the battery receptacle 36 and a surface 130 of the top wall 38. In the illustrated embodiment, the water-tight seal 124 is accomplished by the gasket 118. Specifically, the gasket 118 is positioned in sealing contact with the peripheral surface 126 and with the surface 130 of the top wall 38. The gasket 118 resides between the flange 114 and the top wall 38. The gasket 118 can be formed from a pliant or compressible material, such as an elastomer (e.g., rubber). In other embodiments, the water-tight seal 124 can instead be established by an adhesive can be positioned between flange 114 and the top wall 38 in place of the gasket. In further embodiments, the water-tight seal 124 can be established by clamping or compressing the peripheral surface 126 of the battery receptacle 36 directly against the surface 130 of the top wall 38, e.g., via a bracket, a clamping mechanism, threaded fasteners, or the like (not shown). As shown in FIG. 8, the top wall 38 also defines a rib 134 which surrounds the top wall aperture 60 and which protrudes toward the gasket 118. The rib 134 presses against the gasket 118 and compresses the gasket 118, which improves the quality of the water-tight seal 124. In other embodiments (not shown), the rib may alternatively be formed on the flange 114 of the battery receptacle 36 and protrude toward the gasket 118.

With reference to FIGS. 8 and 9, in the same or other embodiments, the battery charger 10 includes a conduit 142 positioned within the housing assembly 34 and coupled to the partially closed end 66 of the battery receptacle 36. The bottom wall 42 of the housing assembly 34 defines an outlet aperture 146 that is in fluid communication with, or fluidly coupled to, the conduit 142. The conduit 142 is fluidly isolated from the internal space 70 defined within the housing assembly 34. The conduit 142 defines a drain pathway 150 by which water exiting the battery receptacle 36 through the second ingress passageway 86 via the plurality of second apertures 110 can flow to and exit the outlet aperture 146. The conduit 142 captures the water that has entered the battery receptacle 36 and directs the water to the outlet aperture 146, safely bypassing the charging electronics 74. The conduit 142 prevents this water from entering the internal space 70 and interfering with the charging electronics 74 or otherwise becoming trapped within the housing assembly 34.

In the embodiment of FIGS. 8 and 9, the conduit 142 includes a funnel 154 and a flexible tube or a flexible hose 158. The funnel 154 includes a wide end 162 and a narrow end 166 opposite from the wide end 162. The wide end 162 is attached to the partially closed end 66 of the battery receptacle 36 and receives the water draining out from the battery receptacle 36 via the plurality of second apertures 110. The narrow end 166 defines an outlet coupler 170 (e.g., a barbed coupler). A first end 174 of the flexible hose 158 fits onto and couples to the outlet coupler 170. The flexible hose 158 is routed from the outlet coupler 170 to the outlet aperture 146 where it terminates at a second end 178. The second end 178 of the flexible hose 158 can be secured to the bottom wall 42 (e.g., via fasteners), or the second end 178 can simply reside within the outlet aperture 146 by nominal slip fit, or by interference fit.

The funnel 154 includes one or more mounting tabs 182 which correspond to the plurality of screw bosses 122 on the battery receptacle 36. The funnel 154 can be secured to the battery receptacle 36 by threaded fasteners, such as screws (not shown), which pass through the tabs 182 and tighten into the screw bosses 122. In other embodiments (not shown), the funnel 154 can alternatively attach to the battery receptacle 36 by snap fit, or by adhesive.

The funnel 154 also includes a post 186 that projects downward from the wide end 162, beyond the narrow end 166, beside the outlet coupler 170, and terminates beyond the outlet coupler 170. A fastener 190, such as a cable tie, a rubber band, or the like, can attach to the post 186 and to the flexible hose 158. The fastener 190 can redirect the flexible hose 158, e.g., to bend around components such as the charging electronics 74, and to bend toward the outlet aperture 146. In some embodiments, the printed circuit board assembly 78 defines an aperture 194, and the flexible hose 158 is routed through the aperture 194 to the outlet aperture 146.

With reference to FIG. 8, the funnel 154 further defines a wiring aperture 198. The wires 76, which extend between the charging electronics 74 and the charger terminals 30, are routed through the wiring aperture 198. An adhesive 202 can be applied to the wires 76 within the wiring aperture 198 to seal or close the wiring aperture 198, to prevent water from escaping through the wiring aperture 198.

The funnel 154 also includes a sloped wall 206 adjacent the wide end 162 which slopes to direct the water toward the flexible hose 158. Thus, even when the battery charger 10 is places on worksurfaces which are somewhat sloped, i.e., not perfectly horizontal, the relatively steep slope of the sloped wall 206 will still direct water toward the flexible hose 158.

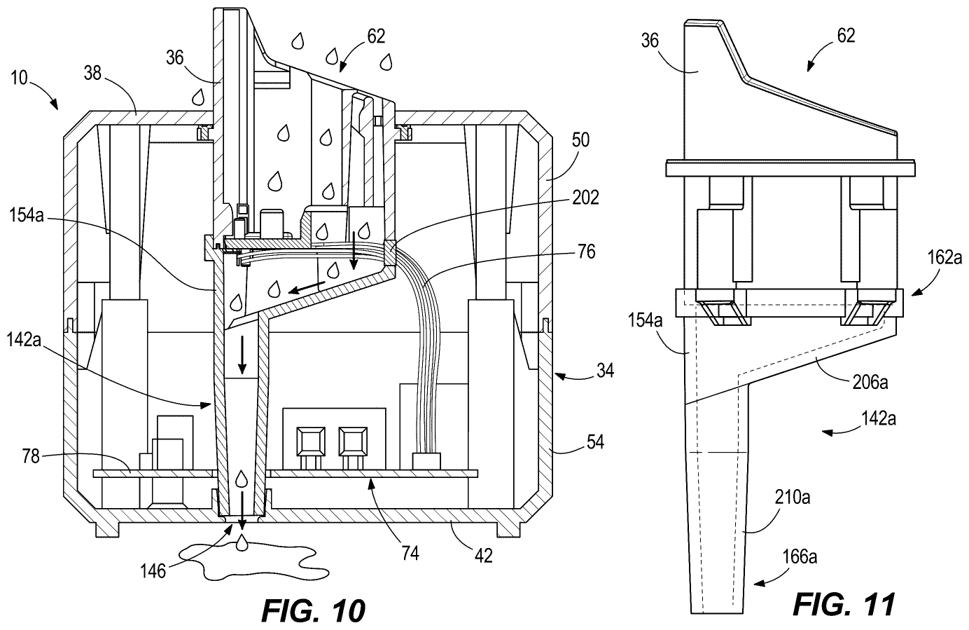

FIGS. 10 and 11 illustrate a conduit 142a that is similar to the conduit 142 described herein and in connection with FIGS. 8 and 9 but has the following differences. The conduit 142a includes an elongated funnel 154a but does not include a flexible hose 158. The elongated funnel 154a extends from a wide end 162a, which is attached to the partially closed end 66 of the battery receptacle 36, to a narrow end 166a, which resides within or is received by the outlet aperture 146. The elongated funnel 154a includes a sloped wall 206a adjacent the wide end 162a which slopes to direct the water toward a tube portion 210a of the elongated funnel 154a, which extends all the way to the outlet aperture 146. Thus, even when the battery charger 10 is places on worksurfaces which are somewhat sloped, i.e., not perfectly horizontal, the relatively steep slope of the sloped wall 206a will still direct water toward the tube portion 210a.

Although the disclosure has been described in detail with reference to certain preferred embodiments, variations and modifications exist within the scope and spirit of one or more independent aspects of the disclosure as described. Various features and/or advantages of the disclosure are set forth in the following claims.

What is claimed is:

1. A battery charger configured to charge a battery pack, the battery charger comprising:
a housing assembly;
a battery receptacle coupled to the housing assembly, the battery receptacle including an open end configured to receive a portion of the battery pack and a partially closed end opposite from the open end;
charging electronics positioned within the housing assembly and electrically connected to the battery receptacle; and
a conduit positioned within the housing assembly, the conduit including a first end fluidly coupled to the partially closed end of the battery receptacle and a second end fluidly coupled to an outlet of the housing assembly.

2. The battery charger of claim 1, further comprising a water-tight seal established between a peripheral surface of the battery receptacle and a surface of the housing assembly.

3. The battery charger of claim 2, wherein the water-tight seal includes a gasket surrounding the battery receptacle.

4. The battery charger of claim 3, wherein the surface of the housing assembly includes a rib configured to compress the gasket.

5. The battery charger of claim 1, wherein the conduit is configured to capture water entering the battery receptacle and direct the water to the outlet.

6. The battery charger of claim 1, wherein the conduit includes a funnel having a wide end and a narrow end opposite from the wide end, and wherein the wide end is connected to the partially closed end of the battery receptacle.

7. The battery charger of claim 6, wherein the narrow end is connected to the outlet of the housing assembly.

8. The battery charger of claim 6, wherein the conduit further includes a flexible hose connecting the narrow end of the funnel to the outlet of the housing assembly.

9. The battery charger of claim 8, wherein the funnel further includes a post projecting from the wide end and extending beside the narrow end.

10. A battery charger configured to charge a battery pack, the battery charger comprising:
a housing assembly;
a battery receptacle coupled to the housing assembly, the battery receptacle including an open end configured to receive a portion of the battery pack and a partially closed end opposite from the open end;
charging electronics positioned within the housing assembly and electrically connected to the battery receptacle; and
a water-tight seal established between a peripheral surface of the battery receptacle and a surface of the housing assembly.

11. The battery charger of claim 10, wherein the water-tight seal includes a gasket surrounding the battery receptacle.

12. The battery charger of claim 11, wherein at least one of the peripheral surface of the battery receptacle and the surface of the housing assembly includes a rib configured to compress the gasket.

13. The battery charger of claim 10, further comprising a conduit positioned within the housing assembly, the conduit including a first end fluidly coupled to the partially closed end of the battery receptacle and a second end fluidly coupled to an outlet of the housing assembly.

14. The battery charger of claim 13, wherein the conduit is configured to capture water entering the battery receptacle and direct the water to the outlet.

15. A battery charger configured to charge a battery pack, the battery charger comprising:
a housing assembly including an upper housing portion and a lower housing portion;
a battery receptacle coupled to the upper housing portion, the battery receptacle including an open end configured to receive a portion of the battery pack and a partially closed end opposite from the open end;
charging electronics positioned within the housing assembly beneath the battery receptacle and electrically connected to the battery receptacle; and
a conduit positioned within the housing assembly, the conduit including a first end fluidly coupled to the partially closed end of the battery receptacle and a second end fluidly coupled to an outlet of the lower housing portion;
wherein the conduit is configured to capture water entering the battery receptacle and direct the water to the outlet.

16. The battery charger of claim 15, further comprising a gasket positioned between a peripheral surface of the battery receptacle and a surface of the upper housing portion.

17. The battery charger of claim 15, wherein the conduit includes a funnel having a wide end and a narrow end opposite from the wide end, and wherein the wide end is connected to the partially closed end of the battery receptacle.

18. The battery charger of claim 17, wherein the narrow end is connected to the outlet of the housing assembly.

19. The battery charger of claim 17, wherein the conduit further includes a flexible hose connecting the narrow end of the funnel to the outlet of the housing assembly.

20. The battery charger of claim 15, wherein:
the battery receptacle further includes a terminal block disposed at the partially closed end;
the battery charger further comprises a wire electrically connecting the terminal block to the charging electronics;
at least one of the battery receptacle and the conduit at least partially defines an aperture through which the wire passes; and
the battery charger further comprises an adhesive that seals the aperture.
